(19) United States
(12) Patent Application Publication
(10) Pub. No.: US 2006/0085116 A1
(43) Pub. Date: Apr. 20, 2006

(54) Arm sensor device in construction machine

(75) Inventors: Hiroshi Suzuki, Tokyo (JP); Hirotaka Iida, Tokyo (JP); Gakuo Shimura, Tokyo (JP); Tomomi Sakonjyu, Tokyo (JP); Yuko Hori, Tokyo (JP); Hiroaki Tada, Tokyo (JP); Satoru Toda, Hyogo (JP)

Correspondence Address: OLIFF & BERRIDGE, PLC, P.O. BOX 19928, ALEXANDRIA, VA, 22320, US

(73) Assignee: Shin Caterpillar Mitsubishi Ltd., Tokyo (JP)

(21) Appl. No.: 10/545,233

(22) PCT Filed: Feb. 5, 2004
(86) PCT No.: PCT/JP04/01232

§ 371 Date: Aug. 12, 2005

(30) Foreign Application Priority Data
Feb. 26, 2003 (JP) 2003-049827
Nov. 28, 2003 (JP) 2003-399780

(51) Int. Cl. G06F 19/00

(52) U.S. Cl. 701/50; 700/245

(57) ABSTRACT

A work machine in which a base end section of an arm is pivotally supported by a tip end section of a boom in the front-and-rear direction in an oscillating manner. The work machine includes an arm angle sensor apparatus for detecting an oscillating angle of the arm so that the arm angle sensor apparatus is protected and an increase in cost is suppressed. A sensor body of the arm angle sensor apparatus is attached to a sensor attachment hole provided in the third boom side plate such that the sensor attachment hole includes a part of the sensor body. The link member for transmitting the oscillating angle of the arm to the sensor body is provided between the third boom side plate and the arm side plate such that one end side is connected to the sensor body and the other end side is connected to the arm side plate.

This application is the national stage of PCT/JP2004/001232, filed Feb. 5, 2004, which claims priority from JP 2003-049827, filed Feb. 26, 2003, and JP 2003-399780, filed Nov. 28, 2003, the disclosures of which are incorporated herein in their entireties by reference thereto.

### BACKGROUND

The disclosure relates to a technical field of an aim angle sensor apparatus in a work machine having an arm, such as a hydraulic shovel.

Generally, a work apparatus attached to a work machine (e.g., a hydraulic shovel) is structured to include a boom in which a base end section is pivotally supported by a machine body in an oscillating manner; an arm in which a base end section is pivotally supported by a tip end section of the boom in an oscillating manner in a front-and-rear direction; and a work attachment, such as a bucket, attached to the tip end section of the arm. Furthermore, such work apparatuses include a so-called offset type work apparatus in which the booms are structured by a first boom in which a base end section is pivotally supported by a machine body in an oscillating manner in a up-and-down direction; a second boom in which a base end section is pivotally supported by the tip end section of the first boom in an oscillating manner in a left-and-right direction; and a third boom that is pivotally supported by the tip end section of the second boom in an oscillating manner in a left-and-right direction and that is connected to the first boom via a link rod to have a parallel displacement to the first boom in a left-and-right direction.

Meanwhile, when a work machine including the work apparatus as described above is provided such that an interference between the work apparatus and a driver seat provided at the side of the machine body is prevented; the load of a suspended load lifted by the work apparatus is measured; or the operation is automated, for example, a boom oscillating angle to the machine body or an arm oscillating angle to the boom must be detected. Thus, a boom angle sensor apparatus or an arm angle sensor apparatus is attached to the work apparatus. These angle sensor apparatuses are structured to include a sensor body which is provided with a rotation angle detection section and a rotor section; and a link member for transmitting the oscillating angle of the boom or the arm to the rotor section of the sensor body. The sensor body has been conventionally attached to an end face of the boom oscillating spindle or arm oscillating spindle. This causes the entire angle sensor apparatus to externally protrude from the oscillating spindle, thus causing a risk in which the protruded angle sensor apparatus may collide with a peripheral object leading to breakage. In the case of the arm angle sensor apparatus in particular, the arm angle sensor apparatus has a long distance from the driver seat and moves in accordance with the operation, thus increasing a risk in which the arm angle sensor apparatus may collide with a neighboring object.

In view of the above, there is a work apparatus in which a face of a sensor body to which an attachment member is attached includes a hole and the hole includes therein a rotation angle detection section of the sensor body so that an amount of the external protrusion of the arm angle sensor apparatus is reduced (see FIG. 1 of Examined Utility Model Registration No. 2582832, for example).

There is another work apparatus in which a sensor body and a link member are provided between left and right side plates for providing arms so that an amount of the external protrusion of the arm angle sensor apparatus is reduced (see FIGS. 6 and 7 of Japanese Patent Publication No. 2877716 and FIGS. 1 and 4 of Japanese Published Unexamined Patent Application No. H11-200424, for example).

The Examined Utility Model Registration No. 2582832 discloses a structure in which a rotor section of the sensor body and a link member for transmitting an arm oscillating angle to the rotor section are externally protruded from an attachment hole in the left-and-right direction. Thus, a risk still remains in which the link member may collide with a peripheral object leading to breakage.

On the other hand, the Japanese Patent Publication No. 2877716 and the Japanese Published Unexamined Patent Application No. H11-200424 disclose a structure such that the link member is provided between the left and right side plates for providing arms and thus the link member can be protected effectively. However, the link member is connected to the tip end section of the cylinder rod of the arm cylinder. This requires a processing for connecting the link member to the tip end section of the cylinder rod (e.g., welding). It is troublesome to do such processing, which will cause an increase in cost. This problem is to be solved by the invention.

The sensor body is also connected with an electric cord for inputting a detected angle to a controller. In the case of the work apparatuses disclosed in the above-described Japanese Patent Publication No. 2877716 and Japanese Published Unexamined Patent Application No. H11-200424, the sensor body is attached to the arm side plate, thus requiring the electric cord to be wired from the machine body including the controller via the boom to the arm. Thus, the electric cord has expansion and contraction in accordance with the oscillation of the arm. Therefore, the electric cord must be wired so as to prevent the electric cord from being broken by interference with other members, for example. This causes another problem in which the wiring layout of the electric cord is complicated. This problem is also to be solved by the invention.

### SUMMARY

The invention was made to prevent the problems as identified above in view of the above situation. A first exemplary embodiment of the disclosure is directed to an arm angle sensor apparatus in a work machine, the work machine having a boom in which a base end section is pivotally supported by a machine body in an up-and-down direction in an oscillating manner and an arm in which a base end section is pivotally supported by a tip end section of the boom in a front-and-rear direction in an oscillating manner, the tip end section of the boom attached to the base end section of the arm so as to hold a pair of left and right arm side plates constituting the arm between a pair of left and right boom side plates constituting the boom, the arm angle sensor apparatus for detecting an oscillating angle of the arm to the boom comprising a sensor body attached to the tip end section of the boom and a link member for transmitting the arm oscillating angle to the sensor body, wherein the sensor body is fitted in an attachment hole provided at any one of the left and right boom side plates such that a part of the sensor body is housed in the attachment hole, and the link member is connected to the sensor body at the one end side and to the arm side plate at the other end side positioning between any one of the left and right boom side plates and the arm side plate at the same side.

A secondary exemplary embodiment of the disclosure is directed to an arm angle sensor apparatus in a work machine, the work machine having a first boom in which a base end section is pivotally supported by a machine body in an up-and-down direction in an oscillating manner; a second boom in which a base end section is pivotally supported by a tip end section of the first boom in a left-and-right (horizontal) direction in an oscillating manner; a third boom in which a base end section is pivotally supported by the tip end section of the second boom in a left-and-right (horizontal) direction in an oscillating manner and which is connected to the first boom via a link rod to have a parallel displacement to the first boom in the left-and-right direction; and an arm in which a base end section is pivotally supported by the tip end section of the third boom in the front-and-rear direction in an oscillating manner, the tip end section of the third boom attached to the base end section of the arm so as to hold a pair of left and right arm side plates constituting the arm between a pair of left and right third boom side plates constituting the third boom, the arm angle sensor apparatus for detecting an oscillating angle of the arm to the third boom comprising a sensor body attached to the third boom and a link member for transmitting the arm oscillating angle to the sensor body, wherein the sensor body is fitted in an attachment hole provided at any one of the left and right third boom side plates such that a part of the sensor body is housed in the attachment hole, and the link member is connected to the sensor body at the one end side and to the arm side plate at the other end side positioning between any one of the left and right third boom side plates and the arm side plate at the same side.

Further, the sensor body can include a rotation angle detection section and a rotor section connected to the link member so as to transmit the arm oscillating angle to the rotation angle detection section, and the sensor body is attached such that at least a part of the rotor section protrudes from the attachment hole to the inside in the left-and-right direction of the boom side plate or the third boom side plate.

Additionally, the sensor body can include a rotation angle detection section and a rotor section connected to the link member so as to transmit the arm oscillating angle to the rotation angle detection section, and the sensor body is attached such that at least a part of the rotation angle detection section protrudes from the attachment hole to the outside in the left-and-right direction of the boom side plate or the third boom side plate.

Further, the sensor body can include an attachment seat for attaching the sensor body to the boom side plate or the third boom side plate and a spacer inserted between the attachment seat and the boom side plate or the third boom side plate in order to adjust an amount of protrusion of the rotor section and/or the rotation angle detection section from the boom side plate or the third boom side plate.

In the first exemplary embodiment, the arm angle sensor apparatus is provided such that a part of the sensor body and the link member are positioned between the attachment hole provided at the boom side plate and the boom side plate and the arm side plate and thus is prevented from being outwardly protruded in the left-and-right (horizontal) direction. Thus, the arm angle sensor apparatus can be protected efficiently and one end side of the link member is connected to the arm side plate. Therefore, no troublesome processing, such as welding for connecting the link to the tip end section of the cylinder rod of the arm cylinder, is required, thus contributing to a suppression of cost. Furthermore, the structure in which the sensor body is attached to the boom side provides another advantage in which wiring of the electric cord connected to the sensor body can be performed easily when compared to a case where the cord is attached to the arm side.

In the second exemplary embodiment, the arm angle sensor apparatus is provided such that a part of the sensor body and the link member are positioned between the attachment hole provided at the third boom side plate and the arm side plate and thus is prevented from being outwardly protruded in the left-and-right (horizontal) direction and the arm angle sensor apparatus can be protected efficiently. One end side of the link member is connected to the arm side plate. Thus, no troublesome processing, such as a welding for connecting the link to the tip end section of the cylinder rod of the arm cylinder, is required, thus contributing to a suppression of cost. Furthermore, the structure in which the sensor body is attached to the third boom side provides another advantage in which wiring of the electric cord connected to the sensor body can be performed easily when compared to a case where the cord is attached to the arm side plate.

Further, the rotor section can be connected to the link member easily and/or the electric cord can be drawn from the rotation angle detection section easily.

Lastly, the amount of the protrusion of the rotor section and/or the rotation angle detection section from the boom side plate or the third boom side plate can be adjusted easily. Thus, the adjustment of the alignment of the rotor section to the link member and/or the avoidance of the interference between the rotor section and a hydraulic hose or a harness provided at the inner side of the boom side plate or the third boom side plate in the left-and-right direction can be performed appropriately, for example.

### BRIEF DESCRIPTION OF THE DRAWINGS

The invention will be described with reference to the drawings, in which:

FIG. 1 is a side view illustrating a hydraulic shovel;

FIG. 2 is a side view of the main part illustrating the first embodiment;

FIG. 3 is a front view of the main part illustrating the first embodiment;

FIG. 4 is a top view of the main part illustrating the first embodiment;

FIGS. 5A and 5B are a front view and a side view of a sensor body, respectively;

FIG. 6 is a cross-sectional view illustrating the sensor body;

FIG. 7 is a side view of the main part illustrating the second embodiment;

FIG. 8 is a front view of the main part illustrating the second embodiment; and

FIG. 9A is a front view illustrating a spacer and FIG. 9B is a cross-sectional view taken at “9-9” of FIG. 9A.

### DETAILED DESCRIPTION OF PREFERRED EMBODIMENTS

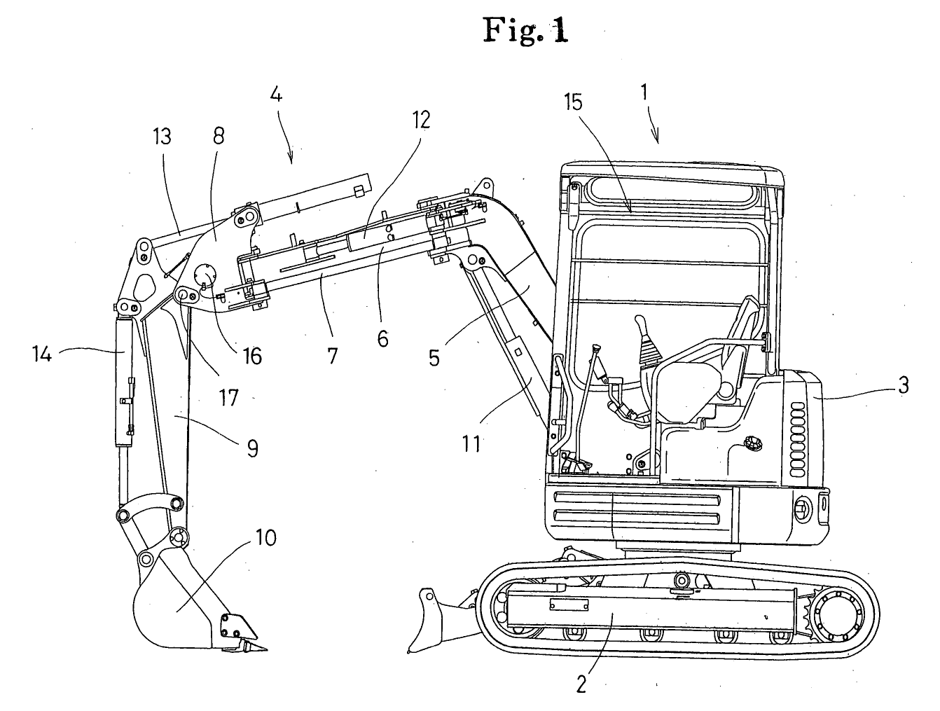

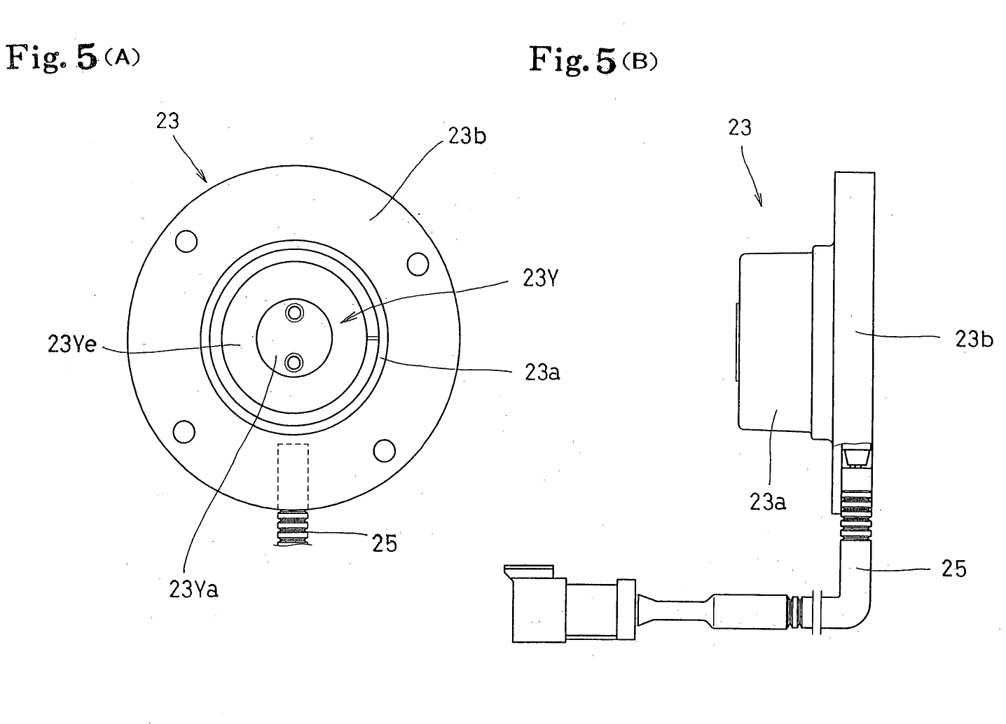

Next, a first exemplary embodiment will be described with reference to FIGS. 1 to 6. In these drawings, the reference numeral 1 denotes an offset type hydraulic shovel. The hydraulic shovel 1 is structured to include a crawler type lower structure 2, an upper structure 3 rotatably supported by the lower structure 2; and a work apparatus 4 attached to the upper structure 3. The work apparatus 4 is basically structured, as in the art, to include a first boom 5 in which a base end section is pivotally supported by the upper structure 3 in an oscillating manner in an up-and-down direction; a second boom 6 in which a base end section is pivotally supported by the tip end section of the first boom 5 in an oscillating manner in a left-and-right (horizontal) direction; a third boom 8 in which the base end section is pivotally supported by the tip end section of the second boom 6 in an oscillating manner in a left-and-right (horizontal) direction and which is connected to the first boom 5 via a link rod 7 to have a parallel displacement to the first boom 5 in a left-and-right direction; an arm 9 in which a base end section is pivotally supported by the tip end section of the third boom 8 in an oscillating manner in a front-and-rear direction; a bucket 10 attached to the tip end section of the arm 9; a boom cylinder 11 for allowing the first boom 5 to be oscillated in the up-and-down direction; an offset cylinder 12 for allowing the second boom 6 to be oscillated in the left-and-right direction; an arm cylinder 13 for allowing the arm 9 to be oscillated in the front-and-rear direction; and a bucket cylinder 14 for allowing the bucket 10 to be oscillated, for example.

The hydraulic shovel 1 is provided with an interference avoidance mechanism for avoiding interference between a driver seat 15 on which an operator sits and the work apparatus 4. Although not shown, the interference avoidance mechanism is structured to include, for example, a boom angle sensor apparatus for detecting an oscillating angle of the first boom 5 to the upper structure 3; an offset angle sensor apparatus for detecting an oscillating angle of the second boom 6 to the first boom 6; an arm angle sensor apparatus 16 (which will be described later) for detecting an oscillating angle of the arm 9 to the third boom 8; a plurality of control valves for providing a control for supplying, exhausting, or stopping pressurized oil for the purpose of avoiding interference to the respective boom cylinder 11, the offset cylinder 12, and the arm cylinder 13; a controller for inputting detected angle signals from the respective angle sensor apparatuses to output, based on the inputted signals, control instructions to the control valves (although not shown, the controller is included in the upper structure 3).

Additionally, the tip end section of the third boom 8 and the base end section of the arm 9 are pivotally supported in an oscillating manner via the spindle 17 extending transverse to the third boom 8 and arm 9. The spindle 17 is mounted in the manner as described below.

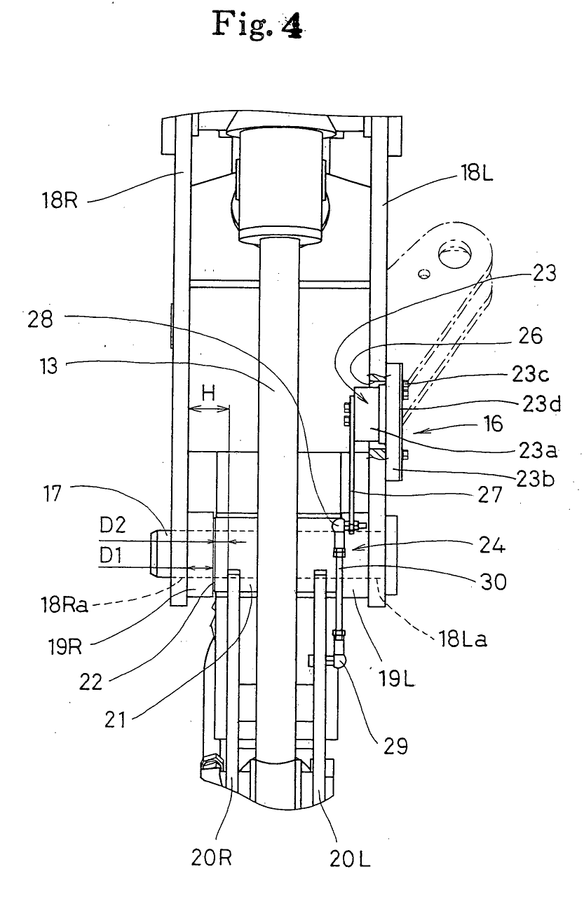

Specifically, a pair of left and right third boom side plates 18L, 18R, constituting the third boom 8, include spindle penetration holes 18La, 18Ra (FIG. 4) while the left and right inner side faces of the third boom side plates 18L, 18R of the portion are integrated with ring-like attachment bases 19L, 19R. On the other hand, a pair of left and right arm side plates 20L, 20R constituting the arm 9 are integrated with a cylindrical boss cylinder section 21 to connect the left and right arm side plates 20L, 20R to each other. The left and right end sections of the boss cylinder section 21 are outwardly protruded from the left and right arm side plates 20L, 20R in the left-and-right (horizontal) direction. With the attachment bases 19L, 19R being aligned at the left and right end sides of the boss cylinder section 21, the spindle 17 inserted to the spindle penetration hole 18La of the left side third boom side plate 18L is inserted to the left side attachment base 19L, the boss cylinder section 21, the right side attachment base 19R, and the axial penetration hole 18Ra of the right side third boom side plate 18R in this order (or the spindle 17 also may be inserted to the right side third boom side plate 18R), thereby allowing the base end section of the arm 9 to be mounted via the spindle 17 to the tip end section of the third boom 8 in an oscillating manner while allowing the pair of left and right third boom side faces 18L, 18R to sandwich the pair of left and right arm side plates 20L, 20R. In this case, one of the left and right third boom side plates 18L, 18R and one of the arm side plates 20L, 20R have therebetween the space H that is substantially equal to the sum of the thickness D1 of the attachment bases 19L, 19R and the protrusion amount D2 of the boss cylinder section 21 with regards to the arm side plates 20L, 20R. In the drawings, the reference numeral 22 denotes a shim inserted between the attachment bases 19L, 19R and the left and right end faces of the boss cylinder section 21.

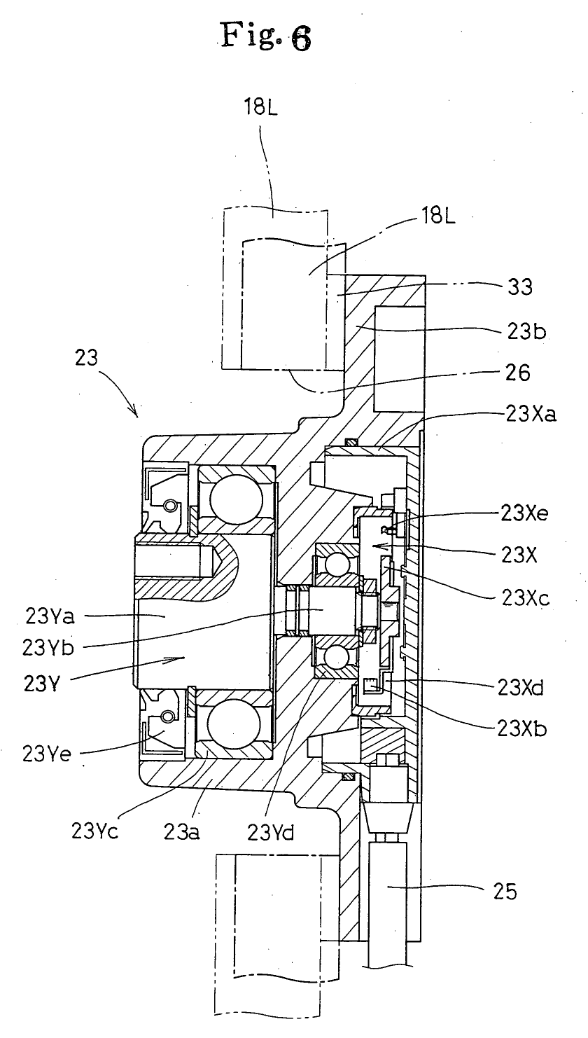

On the other hand, the arm angle sensor apparatus 16 is used, as described above, to detect the oscillating angle of the arm 9 to the third boom 8. The arm angle sensor apparatus 16 is composed of a sensor body 23 having a case body 23a in which a rotation angle detection section 23X (FIG. 6) and a rotor section 23Y are housed; and a link member 24 (FIG. 4) connected to the rotor section 23Y so as to transmit the oscillating angle of the arm 9 to the sensor body 23.

The case body 23a of the sensor body 23 has a cylindrical shape. As shown in FIG. 6, the rotation angle detection section 23X is housed in the case body 23a at one half side in the axial direction while the rotor section 23Y is housed at the other half side in the axial direction.

The rotation angle detection section 23X is provided by a potentiometer, for example. Housed inside a cover body 23Xa, which has a cylindrical shape with a shallow bottom, are a wiper 23Xb, a wiper holder 23Xc, a resistor body 23Xd, and a terminal 23Xe, for example. From the rotation angle detection section 23X, an electric cord 25 is drawn in order to input the oscillating angle of the arm 9 detected by the rotation angle detection section 23X to the controller.

The rotor section 23Y includes a larger-diameter rotor axis section 23Ya and a smaller-diameter rotor axis section 23Yb that are coaxially provided in an integral manner; bearings 23Yc, 23Yd that rotatably support the larger-diameter rotor axis section 23Ya and smaller-diameter rotor axis section 23Yb in the case body 23a in the axial direction; and an oil seal 23Ye, for example. The end section of the larger-diameter rotor axis section 23Ya is connected with a sensor side link 27 (which is a component of the link member 24 and which will be described later) so that the former and the latter are rotated in an integrated manner. On the other hand, the end section of the smaller-diameter rotor axis section 23Yb is connected with the wiper holder 23Xc of the rotation angle detection section 23X so that the former and the latter are rotated in an integrated manner. Thus, the oscillating angle of the arm 9 transmitted via the link member 24 to the rotor section 23Y is inputted to the rotation angle detection section 23X.

The sensor body 23 is attached, in the manner as described below, to the third boom side plate 18L at the left side (the term “the left side” represents the left side as viewed by an operator at the driver seat 15 and the terms “left” and “right” in the following description represent the left and right sides as viewed by an operator at the driver seat 15 and do not represent the left and right sides in the drawings).

Namely, the left side third boom side plate 18L has, at a portion provided at a position slightly closer to the base end side than the above-described part pivotally supported by the spindle 17, a sensor attachment hole 26 that has a larger diameter than that of the case body 23a of the sensor body 23. On the other hand, the case body 23a is provided integrally with an attachment seat 23b having a larger diameter than that of the sensor attachment hole 26 at the part at the outer periphery side of the above-described rotation angle detection section 23X. The sensor body 23 is attached to the left side third boom side plate 18L with the axial intermediate section of the case body 23a: fitted in the sensor attachment hole 26 and the attachment seat 23b fixed by a bolt 23c to the left side face section of the left third boom side plate 18L via the attachment plate 23d. In this case, in the sensor body 23, the tip end side of the rotor section 23Y (the side connected with the link member 24) protrudes in the right direction further than the right side face of the left third boom side plate 18L (i.e., from the sensor attachment hole 26 to the horizontally inner side) and substantially the entirety of the rotation detection section 23X protrudes in the left direction further than the left side face of the left side third boom side plate 18L (i.e., from the sensor attachment hole 26 to the horizontally outer side) (see FIG. 6. The position of the left side third boom side plate 18L to the sensor body 23 in the first embodiment in FIG. 6 is shown by the dashed lines).

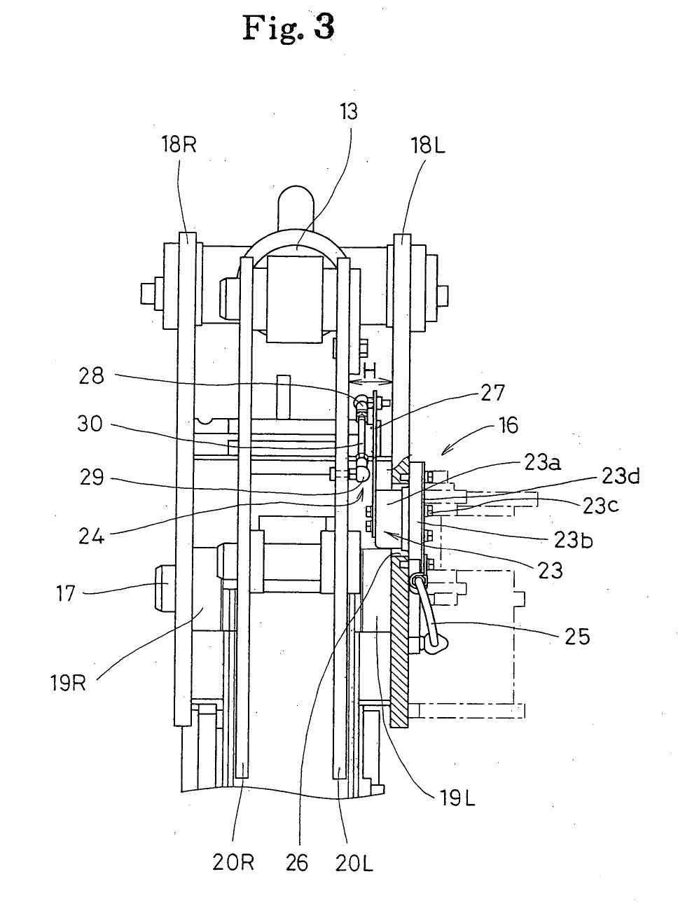

On the other hand, the link member 24 is composed of a sensor side link 27 integrally connected to the end section of the above-described larger-diameter rotor axis section 23Ya in a rotatable manner; and an arm side link 30 in which one end side is connected to the tip end section of the sensor side link 27 via the first ball joint 28 in an oscillating manner and the other end side is connected to the left side arm side plate 20L via the second ball joint 29 in an oscillating manner. The sensor side link 27 and the arm side link 30 are attached so as to be positioned, as shown in FIGS. 3 and 4, in the space H between the left side third boom side plate 18L and the left side arm side plate 20L.

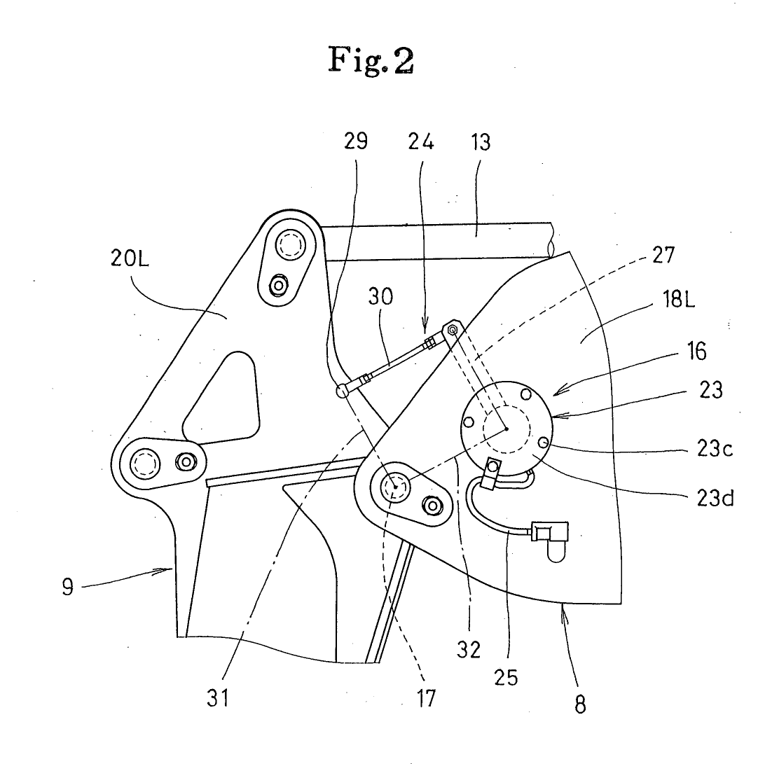

As shown in FIG. 2, a parallelpiped link mechanism is provided by the sensor side link 27; the arm side link 30; a virtual link 31 for connecting the oscillating axial core of the second ball joint 29 at the left side arm side plate 20L to the axial core of the spindle 17; and a virtual link 32 for connecting the axial core of the spindle 17 to the axial core of the rotation axis of the sensor body 23 at the left side third boom side plate 18L. Thus, the oscillating angle of the arm 9 to the third boom 8 is transmitted, via the link member 24, to the rotor section 23X of the sensor body 23.

In the structure as described above, the work apparatus 4 of the hydraulic shovel I is attached with the arm angle sensor apparatus 16 for detecting the oscillating angle of the arm 9 to the third boom 8. The sensor body 23 comprising the arm angle sensor apparatus 16 is fitted in the sensor attachment hole 26 provided at the left side third boom side plate 18L with the tip end side of the rotor section 23Y inwardly protruding from the left side third boom side plate 18L in the left-and-right (horizontal) direction and the substantial entirety of the rotation angle detection section 23X outwardly protruding from the left side third boom side plate 18L in the left-and-right direction. On the other hand, the link member 24 for transmitting the oscillating angle of the arm 9 to the sensor body 23 is connected to the sensor body 23 at the one end side (the base end side of the sensor link 27) and to the left arm side plate 20L at the other end side (the other end side of the arm side link 30), and positioned between the left side third boom side plate 18L and the left side arm side plate 20L.

As a result, the arm angle sensor apparatus 16 is provided such that, although the attachment seat 23b for attaching the sensor body 23 to the left side third boom side plate 18L and the rotation angle detection section 23X provided at the inner periphery of the attachment seat 23b outwardly protrude from the left face of the left side third boom side plate 18L, the rotation angle detection section 23X has a thin shape that is seated in the cover body 23Xa having a shallow bottom. Thus, the rotation angle detection section 23X itself is prevented from outwardly protruding. As a result, a large part of the arm angle sensor apparatus 16 (including the link member 24) is placed in the sensor attachment hole 26 and between the left side third boom side plate 18L provided at the left side third boom side plate 18L and the left side arm side plate 20L. Thus, a defect can be avoided in which the sensor body 23 and/or the link member 24 collide(s) with a peripheral object and being broken for example, thus protecting the arm angle sensor 16 in an effective manner.

Furthermore, the structure allows the arm side link 30, constituting the link member 24, to be connected to the left side arm side plate 20L. This can eliminate troublesome processing, such as welding, required by a structure in which the link is connected to the tip end section of the cylinder rod of the arm cylinder, for example, thus contributing to a suppression of cost.

Furthermore, the electric cord 25 is drawn from the rotation angle detection section 23X of the sensor body 23 in order to input the detected oscillating angle of the arm 9 to the controller provided in the upper structure 3. And because the rotation angle detection section 23X outwardly protrudes from the left side face of the left side third boom side plate 18L, as described above, the electric cord 25 can be drawn easily and, when the electric cord 25 is wired to the upper structure 3, the sensor body 23 attached to the third boom 8 advantageously eliminates the need for considering the oscillation of the arm 9 so that the wiring layout of the electric cord 25 can be provided easily.

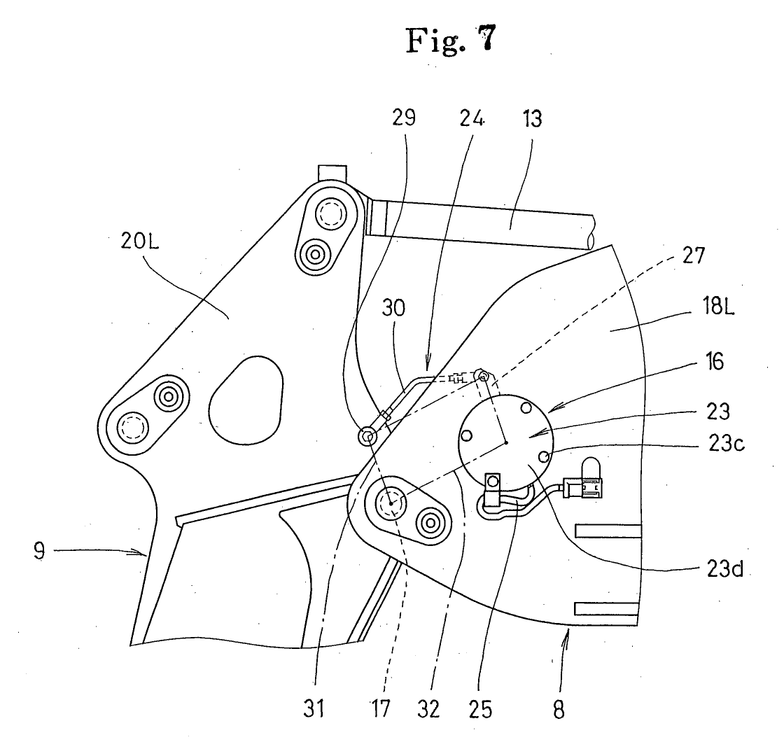

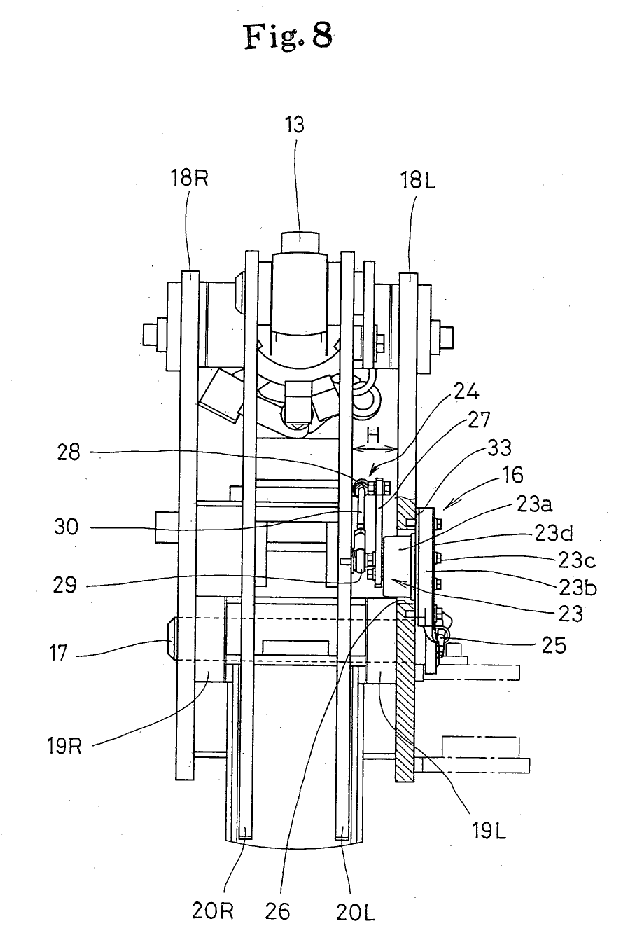

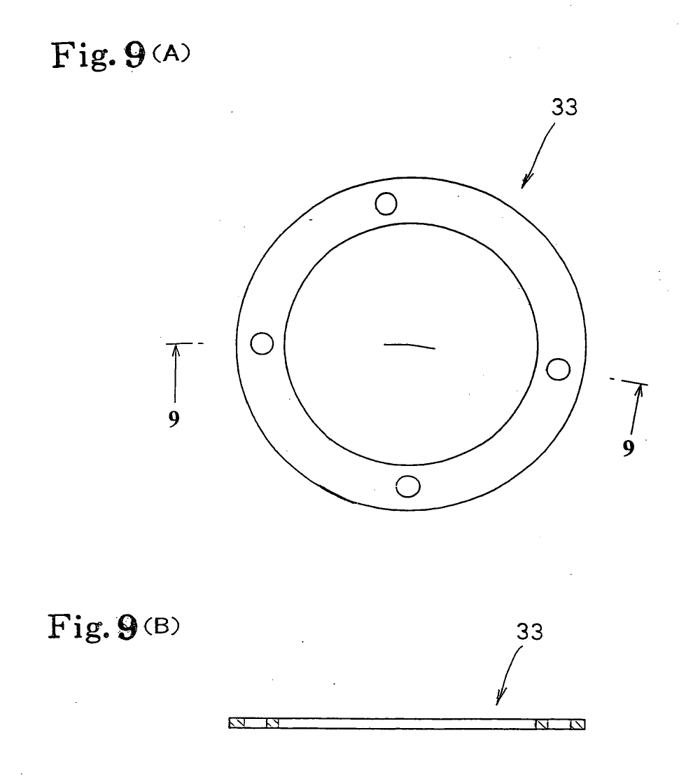

The invention is not limited to the first exemplary embodiment and also can have a structure as in a second exemplary embodiment shown in FIGS. 7 to 9 in which the attachment seat 23b of the sensor body 23 and the left face of the left side third boom side plate 18L have therebetween the spacer 33. The insertion of the spacer 33 as described above can easily adjust the protrusion amount of the rotation detection section 23X or the rotor section 23Y from the left side third boom side plate 18L (see FIG. 6. The positions of the left side third boom side plate 18L and the spacer 33 to the sensor body 23 in the second embodiment in FIG. 6 are shown by the chain double-dashed lines). The use of the spacer 33 to adjust the protrusion amount can appropriately perform the adjustment of the alignment of the rotor section 23Y to the link member 24 and the avoidance of interference between the rotor section 23Y and a hydraulic hose and/or harness (not shown) provided to the left side third boom side plate 18L inwardly in the left-and-right direction, for example.

In the structure in the second exemplary embodiment, the arm side link 30, as shown in FIG. 7, has a different shape from that of the first embodiment. However, the parallelpiped link mechanism is provided, as in the first embodiment, by the sensor side link 27, the arm side link 30, and the virtual links 31, 32.

In the second embodiment, the same components as those of the first embodiment are denoted with the same reference numerals. Those components shown in FIGS. 1, 5, and 6 apply to both of the first and second embodiments.

Furthermore, the invention also can be implemented not only for an arm angle sensor apparatus for constituting an interference avoidance mechanism but also for an arm angle sensor apparatus provided for various objectives, such as measurement of a suspended load lifted by a work apparatus in automation of the work.

Furthermore, the invention can be implemented not only for the offset type hydraulic shovel as in the above embodiments but also for various work machinery, such as a non-offset-type hydraulic shovel, in which a tip end section of the boom pivotally supported by the machine body in an oscillating manner pivotally supports the arm in the front-and-rear direction in an oscillating manner.

As described above, the exemplary embodiments are useful as an arm angle sensor apparatus in a work machine. The exemplary embodiments are particularly useful for a work machine including a so-called offset type work apparatus in which an arm can be moved in the left-and-right direction.

1. A sensor apparatus in a work machine, the work machine having a boom in which a base end section is pivotally supported by a machine body in an up-and-down direction in an oscillating manner and an arm in which a base end section is pivotally supported by a tip end section of the boom in a front-and-rear direction in an oscillating manner, the tip end section of the boom attached to the base end section of the arm so as to hold a pair of left and right arm side plates constituting the arm between a pair of left and right boom side plates constituting the boom, the sensor apparatus comprises:
a sensor body attached to the tip end section of the boom, and
a link member for transmitting an arm oscillating angle with respect to the boom to the sensor body, wherein the sensor body is fitted in an attachment hole provided at any one of the left and right boom side plates such that a part of the sensor body is housed in the attachment hole, and the link member is connected to the sensor body at the one end side and to the arm side plate at the other end side positioning between any one of the left and right boom side plates and the arm side plate at the same side.

2. A sensor apparatus in a work machine, the work machine having a first boom in which a base end section is pivotally supported by a machine body in an up-and-down direction in an oscillating manner; a second boom in which a base end section is pivotally supported by a tip end section of the first boom in a left-and-right direction in an oscillating manner; a third boom in which a base end section is pivotally supported by the tip end section of the second boom in a left-and-right direction in an oscillating manner and which is connected to the first boom via a link rod to have a parallel displacement to the first boom in the left-and-right direction; and an arm in which a base end section is pivotally supported by the tip end section of the third boom in the front-and-rear direction in an oscillating manner, the tip end section of the third boom attached to the base end section of the arm so as to hold a pair of left and right arm side plates constituting the arm between a pair of left and right third boom side plates constituting the third boom,
the sensor apparatus comprises:
a sensor body attached to the third boom; and
a link member for transmitting an arm oscillating angle with respect to the third boom to the sensor body, wherein the sensor body is fitted in an attachment hole provided at any one of the left and right third boom side plates such that a part of the sensor body is housed in the attachment hole, and the link member is connected to the sensor body at the one end side and to the arm side plate at the other end side positioning between any one of the left and right third boom side plates and the arm side plate at the same side.

3. The sensor apparatus according to claim 1, wherein the sensor body includes a rotation angle detection section and a rotor section connected to the link member so as to transmit the arm oscillating angle to the rotation angle detection section, and the sensor body is attached such that at least a part of the rotor section protrudes from the attachment hole to the inside in the left-and-right direction of the boom side plate.

4. The sensor apparatus according to claim 1, wherein the sensor body includes a rotation angle detection section and a rotor section connected to the link member so as to transmit the arm oscillating angle to the rotation angle detection section, and the sensor body is attached such that at least a part of the rotation angle detection section protrudes from the attachment hole to the outside in the left-and-right direction of the boom side plate.

5. The sensor apparatus according to claim 3, wherein the sensor body includes an attachment seat for attaching the sensor body to the boom side plate and a spacer is inserted between the attachment seat and the boom side plate in order to adjust an amount of protrusion of the rotor section and/or the rotation angle detection section from the boom side plate.

6. The sensor apparatus according to claim 2, wherein the sensor body includes a rotation angle detection section and a rotor section connected to the link member so as to transmit the arm oscillating angle to the rotation angle detection section, and the sensor body is attached such that at least a part of the rotor section protrudes from the attachment hole to the inside in the left-and-right direction of the third boom side plate.

7. The sensor apparatus according to claim 2, wherein the sensor body includes a rotation angle detection section and a rotor section connected to the link member so as to transmit the arm oscillating angle to the rotation angle detection section, and the sensor body is attached such that at least a part of the rotation angle detection section protrudes from the attachment hole to the outside in the left-and-right direction of the third boom side plate.

8. The arm angle sensor apparatus according to claim 4, wherein the sensor body includes an attachment seat for attaching the sensor body to the third boom side plate and a spacer is inserted between the attachment seat and the third boom side plate in order to adjust an amount of protrusion of the rotor section and/or the rotation angle detection section from the third boom side plate.
